(19) United States
(12) Patent Application Publication
(10) Pub. No.: US 2024/0230983 A1
(43) Pub. Date: Jul. 11, 2024

(54) SYSTEM AND METHOD FOR FABRICATING MULTIPLEXABLE ACTIVE OPTICAL FIBER SENSORS

(71) Applicant: UNIVERSITY OF PITTSBURGH - OF THE COMMONWEALTH SYSTEM OF HIGHER EDUCATION, PITTSBURGH, PA (US)

(72) Inventors: Peng Kevin Chen, Pittsburgh, PA (US); Kehao Zhao, Pittsburgh, PA (US); Mohan Wang, Pittsburgh, PA (US); Sheng Huang, Pittsburgh, PA (US)

(73) Assignee: UNIVERSITY OF PITTSBURGH - OF THE COMMONWEALTH SYSTEM OF HIGHER EDUCATION, PITTSBURGH, PA (US)

(21) Appl. No.: 18/557,335

(22) PCT Filed: May 9, 2022
(86) PCT No.: PCT/US2022/028308

§ 371 Date: Oct. 26, 2023

Related U.S. Application Data
(60) Provisional application No. 63/186,395, filed on May 10, 2021.

(51) Int. Cl. G02B 6/02; G01D 5/353

(52) U.S. Cl. CPC G02B 6/02147; G01D 5/35312; G01D 5/35316

(57) ABSTRACT

A method of manufacturing an optical fiber sensing device includes steps of moving an optical fiber having a core linearly along a first direction, during the moving, directly writing a number of nanograting structures into the core using a laser beam generated by an ultrafast laser system, wherein the number of nanograting structures form a number of scattering points; and forming an energy transducing element on an outer surface of the optical fiber, wherein the number of scattering points is/are structured and configured to scatter light out of fiber core and into the transducing element to provide local power for the optical fiber sensing device. A system for performing the method is also provided.

### CROSS-REFERENCE TO RELATED APPLICATIONS

This application claims priority under 35 U.S.C. § 119(e) from U.S. provisional patent application no. 63/186,395, titled “Multiplexable Active Optical Fiber Sensors and Methods of Fabrication Thereof” and filed on May 10, 2021, the contents of which are incorporated herein by reference.

### GOVERNMENT CONTRACT

This invention was made with government support under grant #DE-NE0008686 awarded by the Department of Energy (DOE). The government has certain rights in the invention.

### FIELD OF THE INVENTION

The disclosed concept relates to multi-functional optical fiber sensors having functionality that is controlled by in-fiber light, which are known as active fiber sensors. Most particularly, this disclosure pertains to a system and method for fabricating highly multiplexable active fiber sensors.

### BACKGROUND OF THE INVENTION

As passive devices, the functionalities and performances of traditional fiber sensors have been limited by their total passivity. Passive fiber sensors cannot actively adapt to a changing environment. This lack of adaptability has severely limited the application of passive distributed fiber sensors. To enhance the functionalities of fiber sensors, inventors at the University of Pittsburgh have invented an active distributed fiber sensor scheme that can be directly powered by in-fiber light as described in U.S. Pat. Nos. 7,239,778 and 7,349,600, the disclosures of which are incorporated herein by reference.

In contrast to passive sensors, in an active fiber sensing device, optical power is delivered together with a sensing signal through the same sensing fiber. An optical energy conversion membrane coated on the optical fiber serves as a transducer to convert high-power laser energy to other energy forms. The optical characteristics of the fiber can then be adjusted using this optical energy. When the power light is turned off, an in-fiber sensor can be used as a traditional passive sensor; when the power light is turned on, the on-fiber optical tap and energy conversion mechanisms can convert optical energy to thermal, acoustic, and chemical energy for wide array of physical and chemical parameter measurements.

The availability of on-fiber optical power (without need of additional power delivery cable) as just described holds promise to enable optical fibers to perform high spatial resolution measurements of physical and chemical parameters unattainable by passive sensors. These include flow, level, and chemical sensing for extreme environments.

Although active fiber sensors provide significant advantages and advances beyond conventional passive fiber sensors as they can perform multi-parameter measurements, their potential has been severely limited by the lack of multiplexability and manufacturability. Specifically, in the prior art, to harness in-fiber optical power, a specialty high attenuation fiber (HAF) has been used to absorb in-fiber light and convert it to heat for flow measurements. This approach, however, is not multiplexable. Specifically, the fabrication of each active fiber sensor involve the following steps: (1) hydrogen loading of both z standard telecom fiber (SMF-28e+) and the HAF to enhance its photosensitivity, (2) manual stripping of the polymer jackets of both fibers, (3) UV exposure to fabricate a fiber sensor (e.g. FBG) in SMF-28e+, (4) UV exposure to fabricate a fiber sensor (e.g. FBG) in the HAF, (5) manual cleaving of both the FBG in the SMF-28e+ and the FBG in the HAF with high precision (±3 mm), (6) manual fusion splicing of the two of fiber sensor pieces together to form one active fiber sensor. None of these steps can be easily automated. Further, due to guiding mode mismatch between specialty HAFs and standard telecom fibers, significant optical loss will be incurred on fiber splicing junctions. These issues prevent multiplexing of active fiber sensors.

### SUMMARY OF THE INVENTION

These needs, and others, are met by a method of manufacturing an optical fiber sensing device that includes steps of moving an optical fiber having a core linearly along a first direction, during the moving, directly writing a number of nanograting structures into the core using a laser beam generated by an ultrafast laser system, wherein the number of nanograting structures form a number of scattering points; and forming an energy transducing element on an outer surface of the optical fiber, wherein the number of scattering points is/are structured and configured to scatter light out of fiber core and into the transducing element to provide local power for the optical fiber sensing device.

In another embodiment, a system for manufacturing an optical fiber sensing device is provided. The system includes a fiber translation device structured and configured for moving an optical fiber having a core linearly along a first direction, n ultrafast laser system structured and configured to generate and output a laser beam, beam focusing system coupled to the ultrafast laser system, the beam focusing system being structured and configured to focus the laser beam into the core while the optical fiber is being moved linearly by the fiber translation device to enable direct writing of a number of nanograting structures into the core using the laser beam, wherein the number of nanograting structures form a number of scattering points, and a coating device structured and configured to form an energy transducing element on an outer surface of the optical fiber by coating the outer surface with one or more materials, wherein the number of scattering points is/are structured and configured to scatter light out of fiber core and into the transducing element to provide local power for the optical fiber sensing device.

### BRIEF DESCRIPTION OF THE DRAWINGS

A full understanding of the invention can be gained from the following description of the preferred embodiments when read in conjunction with the accompanying drawings in which:

FIG. 1 is a schematic diagram of a system for manufacturing an active optical fiber sensing device according to an exemplary embodiment of the disclosed concept;

FIG. 2 is a schematic diagram of an exemplary optical fiber sensor device made according to a particular exemplary embodiment of the disclosed concept;

FIG. 3 is a schematic diagram of an exemplary optical fiber sensor device made according to another particular exemplary embodiment of the disclosed concept; and

FIG. 4 is a schematic diagram of a system for manufacturing an active optical fiber sensing device according to an exemplary embodiment of the disclosed concept.

### DETAILED DESCRIPTION OF THE INVENTION

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, the term “number” shall mean one or an integer greater than one (i.e., a plurality).

As used herein, the term “ultrafast pulse” shall mean an electromagnetic pulse whose time duration is on the order of one nanosecond or less.

As used herein, the terms “ultrafast laser system” and/or “ultrafast laser source” shall mean a laser system that generates and emits laser pulses that are ultrafast pulses.

As used herein, the term “femtosecond ultrafast pulse” shall mean an ultrafast pulse whose time duration is on the order of 500 femtoseconds or less.

As used herein, the terms “femtosecond ultrafast laser system” and/or “femtosecond ultrafast laser source” shall mean an ultrafast laser system that generates and emits laser pulses that are femtosecond ultrafast pulses.

As used herein, the term “nanograting” shall mean shall mean material damage, defects or modifications to an optical fiber with a feature size of less than 1 um along one dimension (such as the x or y axis) that produces optical scattering, and shall include, for example and without limitation, cracks, fractures, holes, and refractive index changes.

As used herein, the term “Type II modification” shall mean laser induced physical damage or modification of an optical fiber.

The disclosed concept will now be described, for purposes of explanation, in connection with numerous specific details in order to provide a thorough understanding of the subject invention. It will be evident, however, that the disclosed concept can be practiced without these specific details without departing from the spirit and scope of this innovation.

As described in greater detail herein, the disclosed concept addresses and minimizes manufacturing difficulties associated with prior art methods of manufacturing active optical fiber sensor devices. The disclosed concept provides a new and fully automated approach to fabricate active fiber sensors that can be easily multiplexed on a single fiber. An important aspect of the disclosed concept is the use of an ultrafast laser system, which in the exemplary embodiment is a femtosecond ultrafast laser system, in a direct writing approach to directly produce a number of nanogratings (Type II modifications in the exemplary embodiment) in the core of an optical fiber.

More specifically, through spatial laser beam shaping and temporal pulse shaping and through the control of laser processing parameters (such as, without limitation, writing speed, pulse energy and/or duration, repetition rate, polarization states, etc.), a number of nanogratings of various sizes and morphologies can be fabricated in desired locations in and along the fiber core and/or cladding (through the polymer coating of the optical fiber). This enables reel-to-reel continuous fabrication of fiber sensors without stripping the fiber polymer coating.

The laser writing approach of the disclosed concept enables formation of nanogratings or Type-II modifications by laser to produce fiber sensor arrays such as intrinsic Fabry-Perot Interferometers (IFPIs) or fiber Bragg gratings (FBGs). Through control of the laser processing parameters outlined above, these nanogratings can be used as scattering points (also referred to as optical taps) to scatter light out of fiber core to provide local power for the optical fiber sensing device. The out-scattered optical power can be controlled by the size, location, and/or morphology of the nanograting(s) inscribed in the optical fiber. Various energy conversion schemes, such as an optical absorption coating, can then be applied to the scattering points to harness the out-scattered optical energy. More specifically, the out-scattered optical energy may be absorbed and converted into a another energy form, such as heat, electricity, acoustic energy or chemical energy, which can be used to tune one or more in-fiber optic components of the optical fiber sensing device. In the exemplary embodiment, such additional fiber coatings can be deposited on desired location(s) along the fiber using any suitable coating techniques and/or devices as part of a reel-to-reel process as described herein. Such suitable coating techniques and/or devices may include, for example, and without limitation, metal, polymer, and/or ceramic coatings deposited on fibers, or energy conversion structures such as, but not limited to, photovoltaic structures and/or photocatalytic materials place in proximity of the light scattering fibers. Also in the exemplary embodiment, fiber sensors and optical taps can be fabricated in a single laser writing process without the need for any manual procedures. This drastically improves the manufacturability and multiplexability of active fiber sensor technology, which expands its applicability and commercial potential.

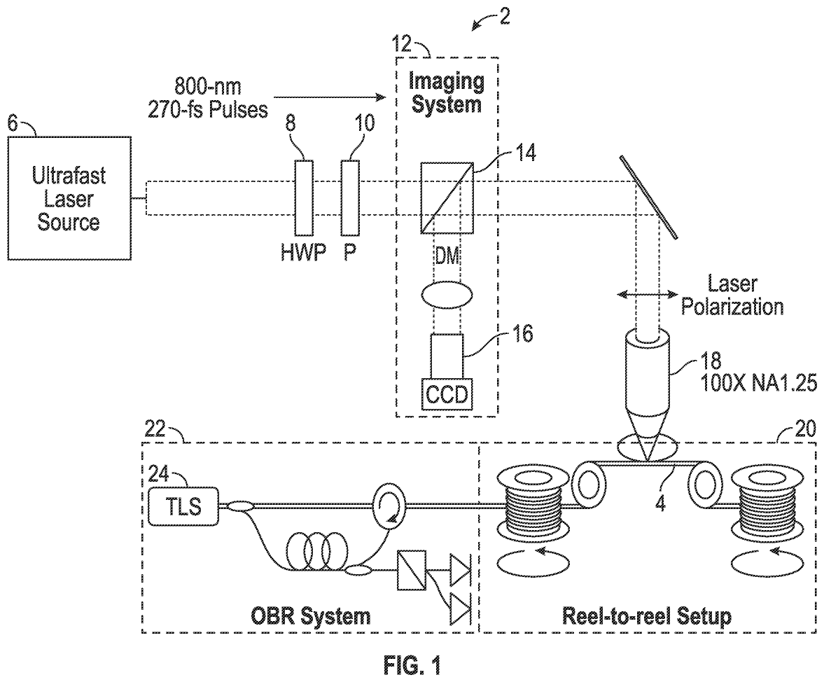

FIG. 1 is a schematic diagram of a system 2 for manufacturing an active optical fiber sensing device 4 according to an exemplary embodiment of the disclosed concept. System 2 includes an ultrafast laser source 6, which in the non-limiting exemplary embodiment is a Coherent RegA 9000 Ti:sapphire laser and amplifier system. In this exemplary embodiment, ultrafast laser source 6 is structured and configured to deliver near-infrared laser pulses of 800-nm wavelength, at a fixed repetition rate of 250 kHz and pulse duration of 270 fs. System 2 further includes a half-waveplate 8, a polarizer 10 (the laser beam's polarization is an important control parameter for nanograting formation as described herein), an imaging system 12 including a dichroic mirror 14 and a CCD camera 16, and an objective lens system 18. In the exemplary embodiment, objective lens system 18 is an oil-immersion objective (100×, NA 1.25) with an index-matching oil (n=1.518). System 2 further includes a reel-to-reel set up 20, which in the non-limiting exemplary embodiment includes optical fiber reels, metal pulleys, fiber tension control structures, 3-D printed fiber supporting structures, and a nano-precision motion stage for cross alignment. Finally, system 2 includes an optical backscattering reflectometer (OBR) system 22 including a tunable laser source 24, which in the exemplary embodiment is the commercially available Luna 4600 OBR interrogator.

In operation, using a three-axis nano-precision motion stage coupled to objective lens system 18 and imaging system 12, the laser beam from ultrafast laser source 6 is able to be focused inside the center of the fiber core of the optical fiber from which optical fiber sensing device 4 is created as described herein to create a number of nanogratings in the fiber core. The directly written nanograting(s) function as optical taps for enabling the out-scattering of light from the optical fiber and into an energy transducing element provided on the optical fiber. More specifically, in the non-limiting exemplary embodiment, the nanograting structures are generated from the type-II laser-material interaction, wherein such nanogratings are known to have exceptional stability under high temperatures. The laser-induced nanogratings as described cause nano-scale physical damage in the fiber core area that than serve as scattering centers for the out-scattering of light from the optical fiber.

In the exemplary embodiment, the use of the oil-immersion objective lens system 18 as described above enables the tight focus of the laser energy into the center of the fiber core, creating a modification area that is 2 μm×2 μm in cross-sectional size and 3 μm long in the axial direction. The reel-to-reel set up 20 enables continuous fabrication of multiple fiber sensors along the optical fiber. During sensor fabrication, OBR system 22 is used to monitor the real-time Rayleigh backscattering profile modification of the fiber under laser irradiation. Thus, in system 2, optical fiber sensor devices such as optical fiber sensor device 4 can be continuously inscribed inside the optical fiber core, and then monitored using OBR system 22 for its characteristics, such as return signal increase and propagation loss.

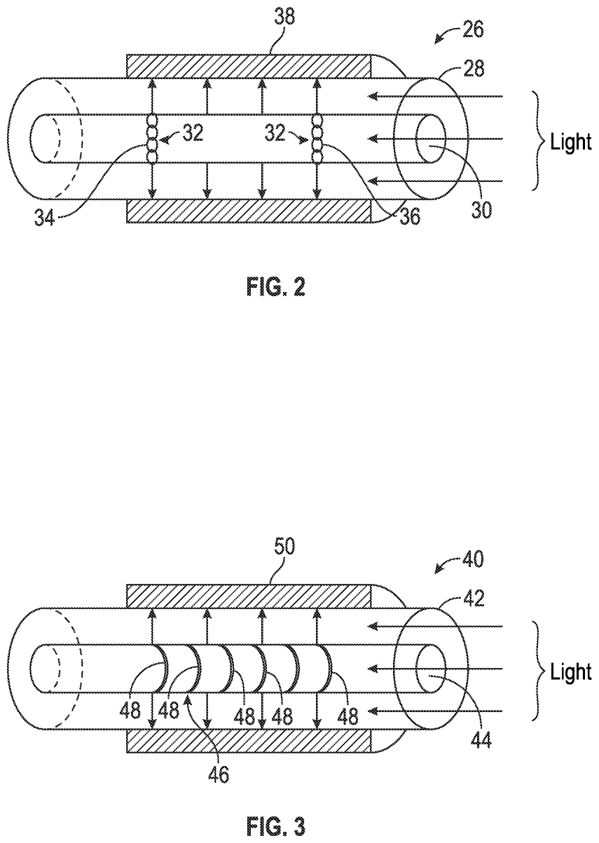

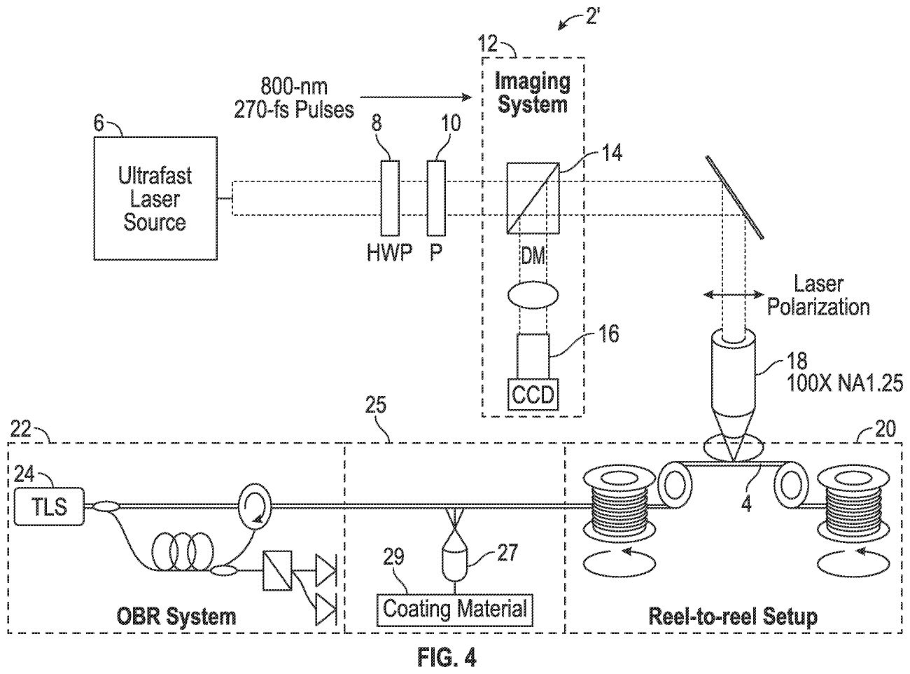

In one particular exemplary embodiment, system 2 is able to produce nanogratings in the form of intrinsic Fabry-Perot interferometers (IFPI). An example of an optical fiber sensor device 26 made according to this particular exemplary embodiment is shown in FIG. 2. Optical fiber sensor device 26 includes an optical fiber 28 having a core 30 (and, in the exemplary embodiment, one or more inner cladding layers and a protecting outer polymer coating) in which IFPI 32 consisting of two parallel reflecting surfaces 34 and 36 is formed by the laser as described above. As noted above, IFPI 32 functions as an optical tap to enable the out-scattering of light from optical fiber 28 as shown by the arrows in FIG. 2. In addition, as seen in FIG. 2, optical fiber sensor device 26 includes an energy transducing element 38 in the form of a coating layer provided on the outer surface of optical fiber 28. Such an energy transducing element 38 may be formed on the outer surface of optical fiber 28 while optical fiber 28 is supported by reel-to-reel set up 20 during sensor fabrication as described herein, using a suitable coating device. In one embodiment, the coating device is provided as part of reel-to-reel set up 20 of the embodiment of FIG. 1. In an alternative embodiment, shown schematically in FIG. 4, a coating station 25 including a separate coating device 27 coupled to a source of coating material 29 may be provided as part of modified system 2′ as shown. In either implementation, suitable coating techniques and/or devices may include, for example, and without limitation, electron beam evaporation, atomic layer deposition, or sputtering coating. As noted above, through cooperation of the out-scattering of light through the optical tap region and the energy transducing element 38, the optical energy is able to be absorbed by energy transducing element 38 and converted into another energy form, such as heat, electricity or acoustic or chemical energy, which can be used to tune IFPI 32 and/or other in-fiber sensor components provided in fiber 28. In various embodiments, energy transducing element 38 may be made of one or more of the following materials: polymers, including photosensitive polymers, semiconductors, metals, and composite materials.

In an alternative particular exemplary embodiment, system 2 is able to produce nanogratings in the form of an array of fiber Bragg gratings (FBGs). An example of an optical fiber sensor device 40 made according to this particular exemplary embodiment is shown in FIG. 3. Optical fiber sensor device 40 includes an optical fiber 42 having a core 44 (an, in the exemplary embodiment, one or more inner cladding layers and a protecting outer polymer coating) in which FBG array 46 consisting of fiber Bragg gratings 48 is formed by the laser as described above. As noted above, FBG array 46 functions as an optical tap to enable the out-scattering of light from optical fiber 42 as shown by the arrows in FIG. 3. In addition, as seen in FIG. 3, optical fiber sensor device 40 includes an energy transducing element 50 that is similar to energy transducing element 38. Thus, through cooperation of the out-scattering of light through the optical tap region and the energy transducing element 50, the optical energy is able to be absorbed by energy transducing element 50 and converted into another energy form, such as heat, which can be used to tune FBG array 46 and/or other in-fiber sensor components provided in fiber 28. In various embodiments, energy transducing element 50 may be made of one or more of the following materials: polymers, including photosensitive polymers, semiconductors, metals, and composite materials.

In one particular exemplary embodiment of the process of generating scattering points through laser processing of the disclosed concept, the writing speed is 0.1 mm/s, the repetition rate is 250K Hz, the polarization state is circularly polarized, the duty cycle is 0.1, and the pulse duration is 180 fs. On the basis of these parameters, it has been found that the FBG sensor that is produced when the average power of the on target is 33 mW-40 mW works better. When the on target average power is less than 33 mW, type II modification cannot be reliably generated, and when the on target average power is greater than 40 mW, the fiber may be easily damaged. As noted elsewhere herein, the power of the out-scattered light can be controlled by the size and location of the nanogratings. When the length of the nanogratings in the fiber grows along the axial direction, the light power scattered out increases. When the nanograting is located at the surface between the core and the cladding of the fiber, the light power scattered out will be stronger than the light power when the nanograting is located at the center of the core. The choice of these parameters depends on the specific application and there is no specific combination that is preferred.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A method of manufacturing an optical fiber sensing device, comprising:
moving an optical fiber having a core linearly along a first direction;
during the moving, directly writing a number of nanograting structures into the core using a laser beam generated by an ultrafast laser system, wherein the number of nanograting structures form a number of scattering points; and
forming an energy transducing element on an outer surface of the optical fiber, wherein the number of scattering points is/are structured and configured to scatter light out of fiber core and into the transducing element to provide local power for the optical fiber sensing device.

2. The method according to claim 1, wherein the forming the energy transducing element is performed during the moving.

3. The method according to claim 1, wherein the number of nanograting structures form an intrinsic Fabry-Perot Interferometer.

4. The method according to claim 1, wherein the number of nanograting structures form a fiber Bragg grating array.

5. The method according to claim 1, wherein the ultrafast laser system is a femtosecond ultrafast laser system.

6. The method according to claim 1, wherein the moving the optical fiber linearly along the first direction is performed using a reel-to-reel setup.

7. The method according to claim 1, further comprising, during the moving and during or after the writing, monitoring one or more optical characteristics of the optical fiber.

8. The method according to claim 7, wherein the monitoring is performed using an optical backscattering reflectometer system.

9. The method according to claim 7, wherein the one or more optical characteristics include a Rayleigh backscattering profile modification.

10. The method according to claim 7, wherein the one or more optical characteristics include a return signal increase and/or a propagation loss.

11. The method according to claim 1, wherein the optical fiber includes at least one of a cladding layer and a protective coating layer, and wherein the directly writing of the number of nanograting structures is performed through the at least one of the cladding layer and the protective coating layer.

12. A system for manufacturing an optical fiber sensing device, comprising:
a fiber translation device structured and configured for moving an optical fiber having a core linearly along a first direction;
an ultrafast laser system structured and configured to generate and output a laser beam;
a beam focusing system coupled to the ultrafast laser system, the beam focusing system being structured and configured to focus the laser beam into the core while the optical fiber is being moved linearly by the fiber translation device to enable direct writing of a number of nanograting structures into the core using the laser beam, wherein the number of nanograting structures form a number of scattering points; and
a coating device structured and configured to form an energy transducing element on an outer surface of the optical fiber by coating the outer surface with one or more materials, wherein the number of scattering points is/are structured and configured to scatter light out of fiber core and into the transducing element to provide local power for the optical fiber sensing device.

13. The system according to claim 12, wherein the coating device is structured and configured to form the energy transducing element while the optical fiber is being moved linearly by the fiber translation device.

14. The system according to claim 12, wherein the ultrafast laser system is a femtosecond ultrafast laser system.

15. The system according to claim 12, wherein the fiber translation device includes a reel-to-reel setup.

16. The system according to claim 12, further comprising a monitoring device for monitoring one or more optical characteristics of the optical fiber while the optical fiber is being moved linearly by the fiber translation device.

17. The system according to claim 16, wherein the monitoring device comprises an optical backscattering reflectometer system.

18. The system according to claim 16, wherein the one or more optical characteristics include a Rayleigh backscattering profile modification.

19. The system according to claim 16, wherein the one or more optical characteristics include a return signal increase and/or a propagation loss.

20. The method according to claim 1, wherein during the directly writing, an average power of the laser beam is 33 mW-40 mW.
